(19) United States
(12) Patent Application Publication
(10) Pub. No.: US 2016/0067945 A1
(43) Pub. Date: Mar. 10, 2016

(54) Multilayer Screen Protective Film

(71) Applicant: Min-Chen Huang, Pingtung County (TW)

(72) Inventor: Min-Chen Huang, Pingtung County (TW)

(73) Assignee: MORECHANGE TECHNOLOGY CO., LTD., Pingtung County (TW)

(21) Appl. No.: 14/527,683

(22) Filed: Oct. 29, 2014

(30) Foreign Application Priority Data
Sep. 10, 2014 (TW) 103216073

(51) Int. Cl. B32B 7/06

(52) U.S. Cl. CPC B32B 7/06; B32B 2457/00; B32B 2307/71

(57) ABSTRACT

A multilayer screen protective film comprises a first protection unit and a second protection unit connected to the first protection unit. The first protection unit further includes a first body having one surface side and the other combined surface, the combined surface arranged on the opposite side of the surface side. The second protection unit, includes a second body and a first adhesive layer which is formed on the second body and towards one surface of the first body, can detachable pasted on one surface side of the first body. The multilayer screen protective film attached to the screen of the electronic products which first protection unit has filter or reduce a blue light resistant function emitted by the screen can protect the eyes of a user. When the second protection unit is used for a period of time and be scraped by foreign objects, the second protection unit can be directly removed, thereby maintaining good visual effect of the screen.

### BACKGROUND OF THE INVENTION

1. Technical Field

This utility patent is a protective film, particularly a multilayer screen protective film.

2. Background Art

There is now widespread use of touch screen of electronic products. In order to protect the screen of the electronic products will not be scraped by foreign objects, there is usually using protective film adhesive for the screen to protect it.

Referring to FIG. 1, this figure illustrates a practice known protective film 1, it includes a thin body 11, a bonding layer 12 located at the one side of the body 11 and release layer 13 attached to the bonding layer 12 and opposed to the body 11. Wherein the bonding layer 12 can be adhered to the other articles. Release layer 13 is used to protect the bonding layer 12. Referring to FIG. 2, the release layer 13 is torn off when using the protective film 1, so the body 11 is attached to a screen 2 by the bonding layer 12.

However, the use of the protective film 1 period of time, the body 11 of the protective film 1 has low hardness, easily be affected by dust and other substances to make screen 2 been scratched, and thus affect the visual effect of the screen 2. In this case, if the user hopes to maintain the visual effect of the screen 2, the user needs to replace the protective film 1 frequently, causing inconvenience in the use of the user.

### SUMMARY OF INVENTION

### Technical Problem

Therefore, the object of this utility patent is to provide a kind of multilayer screen protective film that effectively prolongs the service life without frequent replacement.

### Solution to Problem

The multilayer screen protective film comprises a first protection unit and a second protection unit connected to the first protection unit. The first protection unit further includes a first body having one surface side and the other combined surface, the combined surface arranged on the opposite side of the surface side. The second protection unit, includes a second body and a first adhesive layer which is formed on the second body and towards one surface of the first body, can detachable pasted on one surface side of the first body.

### Advantageous Effects of Invention

The effect of this utility patent in that: When the second protection unit is used for a period of time and be scraped by foreign objects, the second protection unit can directly be removed, thereby maintaining good visual effect of the screen, and without frequently to replace its multilayer screen protective film.

### BRIEF DESCRIPTION OF THE DRAWINGS

Other features and efficacy of the present invention will be clear with reference to the embodiment presented in the drawings, wherein:

FIG. 1 is a side view illustrating a conventional protective film;

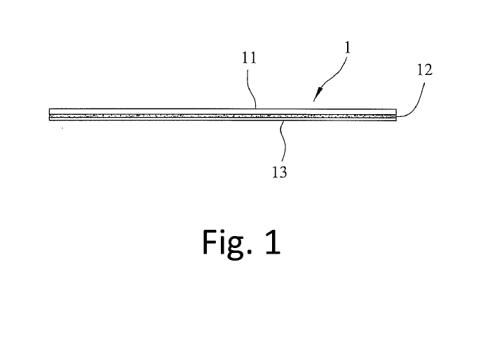

FIG. 2 is an exploded perspective view illustrating the protective film attached to a screen;

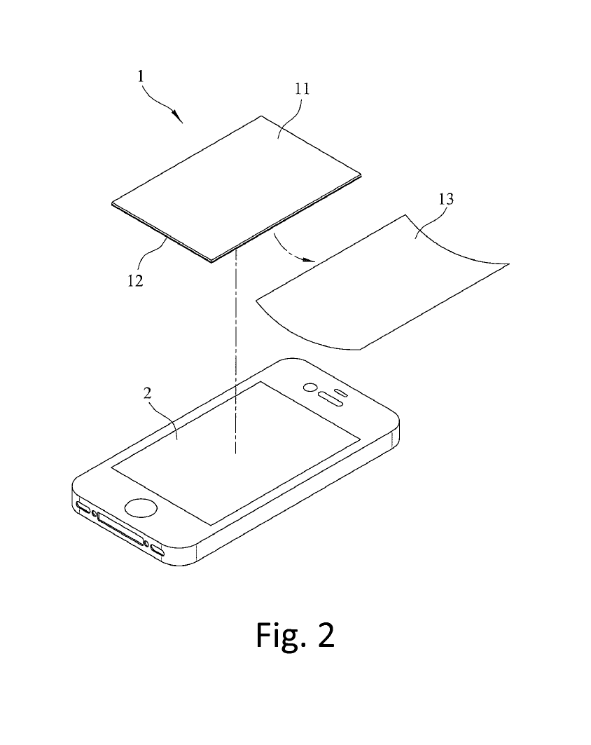

FIG. 3 is a first embodiment of a side view of the multilayer screen protective film;

FIG. 4 is an exploded perspective view illustrating the situation that the first embodiment attached to an electronic product;

FIG. 5 is a diagram illustrating a second protection unit of the first embodiment;

FIG. 6 is a second embodiment of a side view of the multilayer screen protective film; and

FIG. 7 is a diagram illustrating a third protection unit of the second embodiment.

### DESCRIPTION OF THE PREFERRED EMBODIMENTS

Before the utility patent is described in detail, it should be noted in the context of the following description, similar elements to the table ID is not the same.

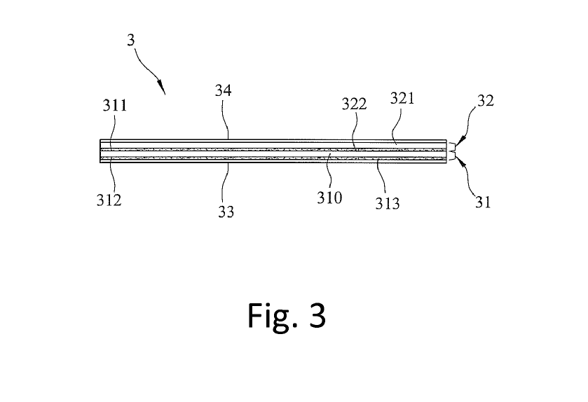

Referring to FIG. 3, the first embodiment of the multilayer screen protective film 3 comprises a first protection unit 31, a second protection unit 32 connected to the first protection unit 31, a first release film 33 attached to the first protection unit 31 and opposed to the second protection unit 32, and a second release film 34 can detachable pasted on the second protection unit 32.

The first protection unit 31 includes a first body 310 and a bonding layer 313 which is formed on the first body 310. The first body 310 having one surface side 311 and one combined surface 312 which arranged on the opposite side of the surface side 311. Wherein the bonding layer 313 is formed on the combined surfaces 312 of the first body 310, and the first release film 33 is attached to the bonding layer 313 and opposed to the first body 310, which release film function is to maintain the viscosity of the combined surfaces 313 and to prevent the bonding layer 313 from dust or foreign body caused the first body 310 cannot be successfully attached to the products that want to be protected.

Recent studies have shown that, the screen of the liquid-crystal display emits the blue-ray causing the eyes easily been hurt to become a chronic injury when looked at the LCD screen for a long time. Therefore, designing a filter or reduce blue-ray function on the protect film become the trend in the field of protective film. The first body 310 of the first embodiment is a blue-ray resistance membrane, which filter or reduce blue-ray function is adopting dyeing, coating or spraying anti-reflection coating to achieve.

The second protection unit 32, includes a second body 321 and a first adhesive layer 322 which is formed on the second body 321 and towards one surface of the first body 310, can detachable pasted on one surface side 311 of the first body 310. Wherein the second body 321 has a first fragrance by the fragrance molecules attached to the second body 321 or added the fragrance molecules when manufacturing the second body 321. Special note is that before applying the first embodiment the second release film 34 can maintain the first fragrance of the second body 321 and avoid the first fragrance disappears before using, also to protect the second body 321 will not be scraped by foreign objects.

It must be noted that, the current technology is quite skilled capacitive touch panel, and has already widely used on the consumer electronic goods. In order to let the user can smoothly use capacitive touch panel when they attached the first embodiment to their buying customer electronic goods, the first protection unit 31 and the second protection unit 32 all need using conductive material.

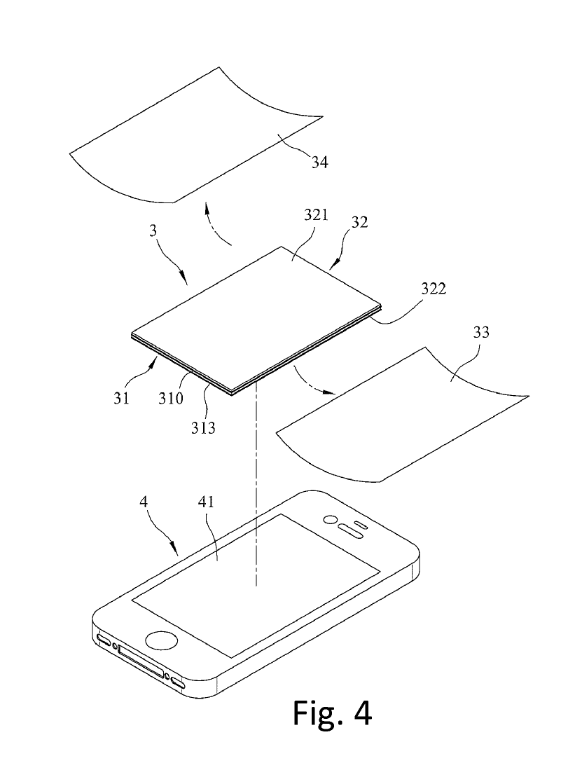

Refer to FIG. 4, when using the first embodiment need to first tear off the first release film 33, then the first body 310 and the second protection unit 32 attached to the screen 41 of the electronic products 4 by the bonding layer 313 of the first protection unit 31. Then, as long as to tear off the second release film 34, the first fragrance belongs to the second body 321 of the second protection unit 32 will be began to distribute, so as to can make external environment full of aroma, and provide users with more comfort.

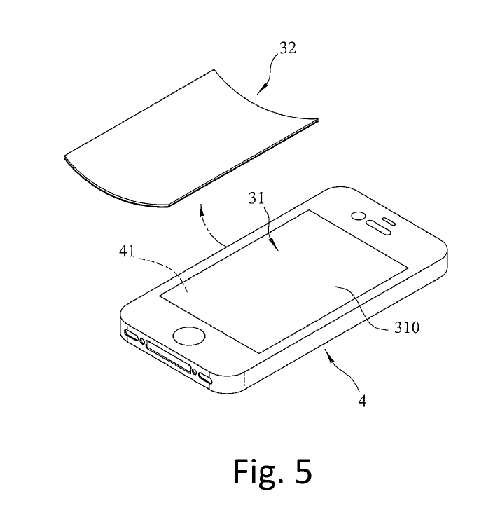

Refer to FIGS. 3 and 5, as a result of the users will frequently finger on the second protection unit 32 by sliding operation of electronic products 4 when the users attached the first embodiment to the screen 41 of the electronic products 4, or the screen 41 be scraped by foreign objects, these will cause the second protection unit 32 having damage phenomenon then influence the visual effect of the screen 41. Then, as long as the second protection unit 32 to tear apart from the first body 310, the first body 310 which not be frayed can protect the screen 41 of the electronic products 4. The users do not need to replace the whole multilayer screen protective film, then can have the original visual effect of the screen 41 by the first body 310 not be frayed, and the service life of the first embodiment is further prolonged.

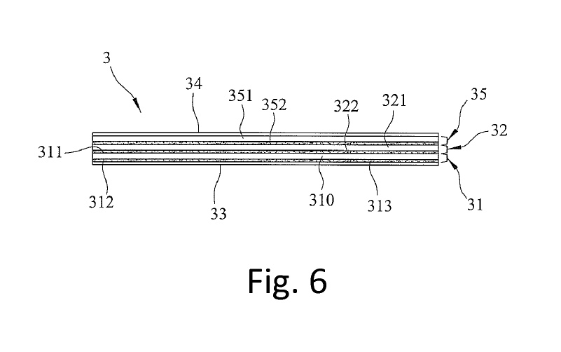

Refer to FIG. 6, it is the second embodiment of the multilayer screen protective film 3. The difference between the first embodiment and the second embodiment is the second embodiment has a third protection unit 35 which can detachable pasted on the second protection unit 32. The third protection unit 35 includes a third body 351 and a second adhesive layer 352 which is formed on the third body 351 and towards one surface of the second protection unit 32. Wherein the third body 351 has a second fragrance. The second release film 34 can detachable pasted on the third protection unit 35, which is to maintain the second fragrance of the third body 351 and avoid the third body 351 be scraped by foreign objects before using.

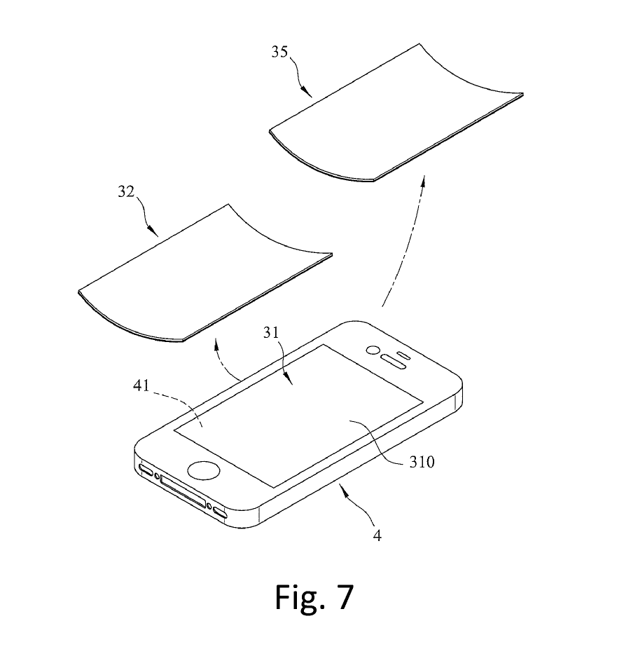

Refer to FIG. 7, the difference between the first embodiment and the second embodiment, when adopting the second embodiment is : the third protection unit 35 of the second embodiment can be removed first. According to the viscosity of the first adhesive layer 322 is stronger than the second adhesive layer 352, users removing the third protection unit 35 first will not tear off the second protection unit 32 at the same time. The second protection unit 32 will still attach to the first protection unit 31 when the third protection unit 35 be removed, and still can achieve the same efficacy embodiment the first embodiment. That is to say, the second embodiment compared with the first embodiment has an additional protective layer called the third protection unit 35. Compared with the first embodiment, the multilayer screen protective film can effectively prolongs the service life again, and according to the special needs to design the adhesive strength of each adhesive layer, also it can set three or more than three protective layers to meet users' needs.

Another to note is that, the time for tearing off the third protection unit 35 except as described in above the frayed situation, remove the third protection unit 35 then use the second protection unit 32 when the second fragrance of the third protection unit 35 dissipate over time, due to the third body 351 of the third protection unit 35 has the second fragrance which can be different or the same with the first fragrance, therefore the first fragrance of the second body 321 of the second protection unit 32 can maintain the aroma in air and keep longer or give the change effect.

In summary, the first body 310 of the first protection unit 31 has a filter or reduce blue-ray function, and the second protection unit 32 and the third protection unit 35 can be removed after using a period of time, therefore prolonging service life of the multilayer screen protective film 3 and without frequently to replace multilayer screen protective film 3, it can really accomplish the purpose of the utility patent.

However, as mentioned above, only the utility patent preferred embodiments, when this cannot be limited to the scope of the implementation of the utility patent, that in almost all the range under this utility patent and utility patent help content made simple the equivalent modifications and alterations of the utility patents are still within the range covered.

1. A multilayer screen protective film comprises:
a first protection unit further includes a first body having one surface side and one combined surface, the combined surface arranged on the opposite side of the surface side; and
a second protection unit includes a second body and a first adhesive layer which is formed on the second body and towards one surface of the first body, can detachable pasted on one surface side of the first body.

2. A multilayer screen protective film as described in the claim 1, wherein the first protection unit includes a bonding layer which is formed on the combined surfaces of the first body.

3. A multilayer screen protective film as described in claim 2 includes also a first release film which is attached to the bonding layer and opposed to the first body.

4. A multilayer screen protective film as described in claim 1, wherein the first protection unit is a blue-ray resistance membrane.

5. A multilayer screen protective film as described in claim 1, wherein the second body has a first fragrance.

6. A multilayer screen protective film as described in claim 1, also includes a second release film which can detachable pasted on the second protection unit.

7. A multilayer screen protective film as described in claim 1, includes also a third protection unit which can detachable pasted on the second protection unit. The third protection unit includes a third body and a second adhesive layer which is formed on the third body and towards one surface of the second protection unit.

8. A multilayer screen protective film as described in claim 7, wherein the viscosity of the first adhesive layer is stronger than the second adhesive layer.

9. A multilayer screen protective film as described in claim 7, wherein the third body has a second fragrance.

10. A multilayer screen protective film as described in claim 7, also includes a second release film which can detachable pasted on the third protection unit.
